(19) United States
(12) Patent Application Publication
(10) Pub. No.: US 2025/0012892 A1
(43) Pub. Date: Jan. 9, 2025

(54) METHODS AND SYSTEMS FOR DETECTION AND AVOIDANCE

(71) Applicant: Matrixspace Corporation, Burlington, MA (US)

(72) Inventors: Matthew T. Kling, Uxbridge, MA (US); Dan William Nobbe, Crystal Lake, IL (US)

(21) Appl. No.: 18/402,370

(22) Filed: Jan. 2, 2024

Related U.S. Application Data
(60) Provisional application No. 63/436,308, filed on Dec. 30, 2022.

(51) Int. Cl. G01S 7/02; G01S 7/41; G01S 13/933

(52) U.S. Cl. CPC G01S 7/0235; G01S 7/411; G01S 13/933

(57) ABSTRACT

Systems and methods are provided for detection and avoidance. An example system may include a plurality of radars and a host machine that includes one or more circuits. Each radar is configured to provide radar measurement capabilities. Each radar is also configured to provide at least a partial field of view coverage. The plurality of radars is configured or arranged to provide an extended coverage detection area based on at least two radars being configured or arranged to provide detection in different directions and/or to have only partial overlap of coverage. The host machine is connected to each radar via a corresponding data connection, and the one or more circuits are configured to manage or control operation of the plurality of radars; process radar measurements obtained via the plurality of radars; and provide or support detection related functions based at least in part on the processing of the radar measurements.

### CLAIM OF PRIORITY

This patent application makes reference to, claims priority to, and claims benefit from U.S. Provisional Patent Application No. 63/436,308, filed on Dec. 30, 2022. The above identified applications is incorporated herein by reference in its entirety.

### TECHNICAL FIELD

Aspects of the present disclosure relate to communication solutions. More specifically, various implementations of the present disclosure relate to methods and systems for detection and avoidance.

### BACKGROUND

Operation of a radio frequency (RF) communication network in a dynamic, and sometimes hostile, RF environment poses many challenges, especially if the nodes in the network are highly mobile and the RF environment is rapidly changing. Each node is subject to interference, and the longer the distance to be covered, the more susceptible nodes are to interfering signals while power and antenna requirements increase.

Further limitations and disadvantages of conventional and traditional approaches will become apparent to one of skill in the art, through comparison of such systems with some aspects of the present disclosure as set forth in the remainder of the present application with reference to the drawings.

### BRIEF SUMMARY

System and methods are provided for detection and avoidance, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

FIG. 1 shows an aerial drone that may be utilized in accordance with an example embodiment of the disclosure.

FIG. 2 shows a drone swarm that has formed a mesh network.

FIG. 3 shows an example drone that may be configured for detection and avoidance in accordance with an example embodiment of the disclosure.

FIG. 4 shows an example implementation of drone that may be configured for detection and avoidance in accordance with an example embodiment of the disclosure.

FIG. 5 shows an example architecture of an artificial intelligence (AI) drone that may be utilized in accordance with an example embodiment of the disclosure.

FIG. 6 shows an example drone incorporating three radar/communication module(s) arranged for providing full field of view.

FIG. 7 shows detection coverage area of an example drone incorporating three radar/communication module(s).

FIG. 8 shows variations in required detection time for different targets relative to a coverage area of an example drone incorporating three radar/communication module(s).

FIG. 9 shows an example timing scheme that may be used in an example drone incorporating three radar/communication module(s).

FIG. 10 shows an example use scenario utilizing an example drone incorporating radar/communication module(s) for use in DAA.

### DETAILED DESCRIPTION

Communications networks involve tradeoffs in range, bandwidth, power, and noise immunity. A mesh network is a form of network where the distance covered can be extended by hopping communications through intermediate nodes. Instead of hopping along a single path, a mesh topology allows a communication link to be set up on any of multiple paths through the mesh. A mesh routing protocol allows a link to be set up between any two nodes over any available path through the mesh. If a link is broken because of interference or loss of a node, the protocol establishes a new route through the mesh. Accordingly, a mesh network is resilient and self-healing.

Existing mesh network implementations use nodes that are largely static or operate with omnidirectional antennas, and operate at relatively lower frequencies. The present disclosure contemplates a mesh network of fixed or highly mobile nodes, with a preferred embodiment that operates as a swarm of aerial nodes, where the mesh may choose paths that reject interference based on directional properties of the node antennas and their transmission and reception. In addition, the network is implemented with millimeter (mm) wave radios. Millimeter wave is high frequency, high-bandwidth, and thus offers higher data rates, than WiFi bands. The mm wave spectrum is also less crowded with competing applications, especially above the highest frequency cellular bands. Another advantage of mm wave is that antenna size decreases with increasing frequency, allowing for more sophisticated, higher gain antennas in smaller, lighter weight packages. Phased array antennas allow for increased gain, and in particular, by adjusting the phase and amplitude of each element in the array, the antenna gain can be adjusted and steered so that the antenna is highly directional and rapidly adjustable, an important feature for the highly dynamic nature of the disclosed mesh network.

In a mesh network of nodes with omnidirectional antennas, an interfering RF emitter will continue to interfere with nearby nodes no matter how the node is oriented relative to the interferer. Even if the node is mobile, changing the orientation of the node or minor adjustments in location are unlikely to alleviate the interference. However, by using a mesh network with directional antennas, such as phased array antennas, for example, nodes that are being interfered with may steer their antennas' beam patterns towards a node that is in a direction with less interference, use or select a different route through the mesh network that uses nodes whose antenna orientation is not aligned with the source of interference, and/or adjust the beam pattern so that a notch or null in the beam pattern is aimed at the interferer while only losing a slight amount of gain relative to peak gain. Nearby nodes that are within range of the interferer may also make these adjustments to their beam pattern as well. This may be done at high speed, with physically moving the node in space maintained as another option.

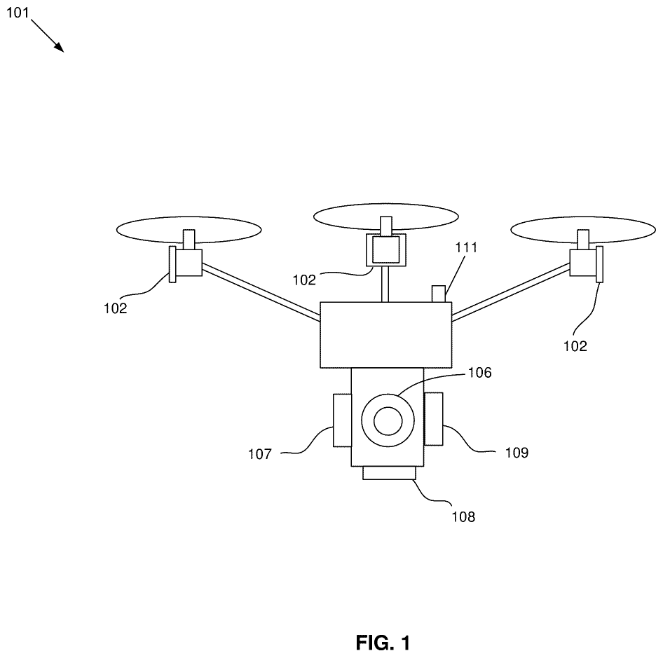

FIG. 1 shows an aerial drone that may be utilized in an accordance with an example embodiment of the disclosure. Shown in FIG. 1 is drone 100. The drone 100 is not crewed, and is preferably lightweight with a useful payload on the order of 10 pounds. However, the drone is not so limited, and as used herein, drone may refer to any unmanned aerial vehicle (UAV) as understood in the art. The drone 100 is equipped with directional, planar phased array antennas 102. While FIG. 1 only has three motor/blade mechanisms visible, there is a fourth directly behind the front one, although a higher number may be utilized, such as six, eight, or twelve for example. The arrays 102 can be mounted on any convenient surface on the drone to achieve the desired coverage based on the capability of the array, as further explained herein.

The drone is also equipped with sensors for collecting information. In the embodiment shown, the sensors include an optical imager 106, an infrared sensor 107, a LIDAR imager 108, an acoustic sensor 109, radar, and software-defined radio (SDR) for RF spectral sensing. The drone may comprise additional hardware for guidance, including a satellite position system antenna 111 and an inertial “dead reckoning” accelerometer and magnetic compass (not shown). The phased array antennas may be of any size, but are shown as 4×4 arrays in this embodiment, with an element size designed for the millimeter wave range, generally in the range of 10 to 200 GHz. While any operating frequency could be chosen, the preferred embodiment operates at 24 GHz. In this mode of operation, line of sight communication of the radio links described herein is reasonable out to a single digit mile radius, with link distances typically under one mile.

Altitude is an important parameter for locating the drone in space, and essential for avoiding terrain. The drone preferably employs a combination of techniques for determining and maintaining altitude. Laser range finding, such as LIDAR, provides fast and accurate altitude information provided visibility is good. An on-board pressure altimeter provides a secondary reference, and the phased array antennas 102 may be used to provide ranging information to points on the ground using trigonometry if the ground surface is sufficiently reflective. Satellite provided Global Positioning System (GPS) or the like may also provide an estimate of altitude above the surface of the earth. Combining all these sources and comparing them to an on board reference map of the area of operation provides an accurate assessment of current altitude and contributes to a refined assessment of the drone's absolute position in space, further described below.

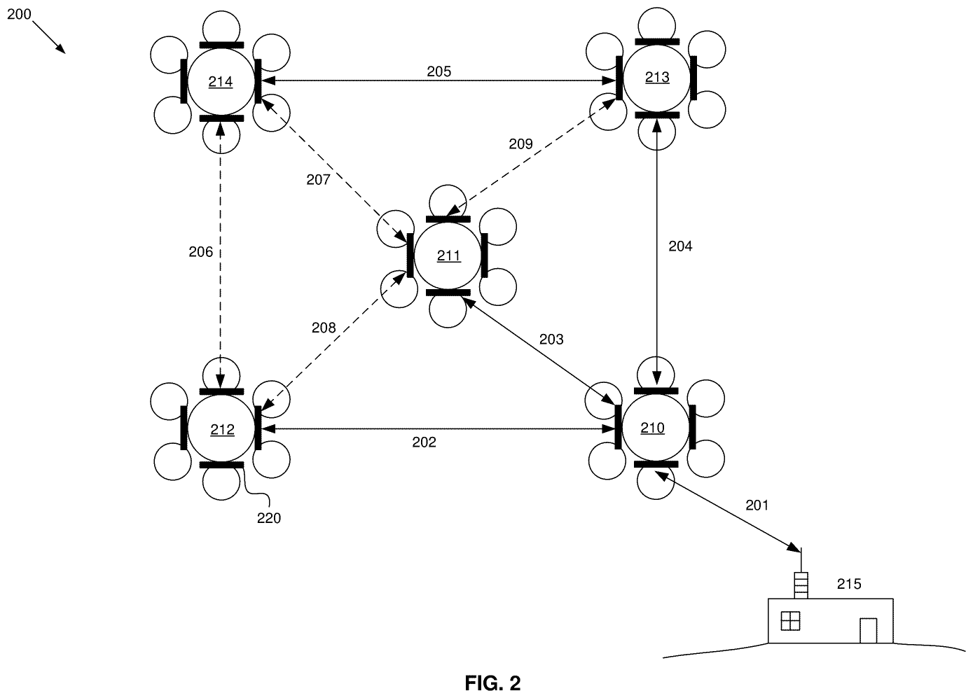

FIG. 2 shows a network 200 of aerial drones 210-214 forming a mesh network of links 201-209. Each of the drones 210-214 may comprise one or more phased array antennas 220, where the number of antenna arrays may ensure full 360° coverage. The network has a root at a ground or base station 215, which is shown as a static location but could also itself, be mobile. Dashed line links 206-209 represent alternate links between drones that are not active. Each drone acts as node in the network. It is not required that all nodes operate at the same frequency, and to avoid interference between nodes that are lined up such that a third further node is in the peak energy beam of a radio link between a first and second node, the network may employ several alternate neighboring frequencies.

Illustrated in FIG. 2 for illustrative purposes is a drone swarm of unmanned aerial vehicles or drones. Each drone in the swarm is also a communications node and is equipped with one or more phased array, electrically steerable antennas and a transceiver operating in the millimeter wave region. Each drone may also be equipped with one or more sensors, such as optical, LIDAR, thermal, or acoustic sensors. The drones carry an on-board processor and memory for controlling the drone's movements, operating the sensors, and managing the transceiver. The drones also carry antennas and a processor for determining position based on satellite data (e.g., Global Positioning System (GPS) or the like) and optionally an on-board inertial and magnetic (compass) sensor. The drones communicate with each other to form a mesh network of communication nodes with an RF link back to a root node, base station, or other target node in the network. The nodes respond to interference from jammers and obstacles by finding new paths through the mesh, steering the millimeter wave beam, re-positioning, or a combination of these techniques.

Path loss of a radio link increases proportional to the square of frequency. For example, going from 2.4 GHz which is roughly a common frequency for cell phones and 2.4 GHz WiFi to 24 GHz would result in a path loss that is 100 times higher, or 20 dB. Going from 2.4 GHz to 80 GHz would have a 30 dB increase in path loss. In a free space propagation condition, the path loss increases by 20 dB for every decade of distance. Therefore, going from 2.4 GHz to 24 GHz would reduce the link distance by a factor of 10, and the link distance for an 80 GHz link would decrease by a factor of 33. However, high frequencies have the benefit of very wide bandwidths and thus faster data rates. Additionally, the size of the antenna decreases with frequency (wavelength), enabling the use of more complex, higher gain antennae to combat the increase in path loss. Higher gain results from focusing the energy, thereby resulting in highly directional antennas.

The phased array antenna consists of numerous antenna that have their amplitude and phase adjusted to steer the beam by adjusting summation and cancellation of signals from various directions. The focusing of the energy, often in both azimuth and elevation, creates a higher gain antenna. However, the very focused beam is preferably pointed in the right direction to facilitate communication. Additionally, the focusing of the beam means the transmission/reception in directions away from the main beam is attenuated, which may enable the avoidance of interference.

Furthermore, the phased antenna arrays may help with isolation of communication channels such as transmitting in one direction and receiving in another. Phased array antennae utilize software to control the gain/phase of each antenna element for steering of the beam, where the system is aware of which direction to steer the beam. The beams may be steered by knowledge of relative GPS locations or drone formation which may be known based on a flight plan or shared over a communications link. The beams may also be steered by scanning the beam and/or with closed-loop tracking. One typical implementation of a phased array antenna uses a planar array of patch antenna elements. This has the advantage of being flat and thus can fit well onto an aircraft without significant size and aerodynamic implications.

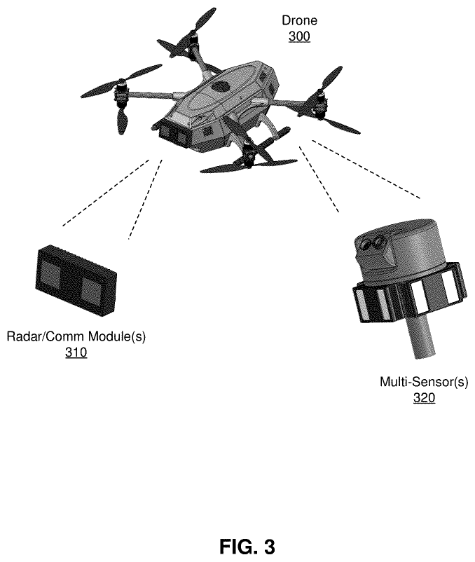

FIG. 3 shows an example drone that may be configured for detection and avoidance in accordance with an example embodiment of the disclosure. Shown in FIG. 3 is an aerial drone 300 (as described herein).

The aerial drone 300 may comprise suitable circuitry and other components (e.g., hardware or otherwise) to facilitate and support detection and avoidance (DAA) in accordance with the present disclosure. In this regard, a drone may be configured, when utilizing detection and avoidance (DAA), to monitor and observe the surrounding environment (e.g., the airspace around the drone), to detect objects and/or other physical obstacles that may pose a threat to the drones or operation thereof (e.g., collusion therewith), to determine when detected objects may pose such a threat, and to determine (and if possible take) action(s) to mitigate such threat (e.g., avoidance maneuvers or other actions by the drone for avoiding the detected objects). In such instances, the drone may utilize defined boundaries and/or other suitable criteria or parameters when performing the detection, when assessing whether detected object may be deemed to pose a threat, when assessing such threat, and/or when determining what actions may be taken. The drone may also configured to determine or otherwise obtain data relating to pertinent characteristics of the detected object(s), such as current position, movement (direction, speed, etc.), and the like. Use of detection and avoidance (DAA) may improve operation of drones, such as by allowing or otherwise enhancing autonomous operation of the drones.

For example, as illustrated in FIG. 3, the aerial drone 300 may comprise one or more radar/communication module(s) 310, one or more advanced sensors 320, and one or more processors (e.g., central processing unit (CPU) processors, graphics processing unit (GPU) processors, etc.). In some instances, the aerial drone 300 may be configured to facilitate or support use of advanced computing/processing based operations, such as artificial intelligence (AI) based operations. In this regard, circuitry and other components (e.g., hardware or otherwise) embedded in (or otherwise made available to) the aerial drone 300 may be configured to support various advanced computing based tasks, such as real-time artificial intelligence (AI) computing/processing and data analytics, which may be used in conjunction with detection and avoidance (DAA) related functions as described herein.

In operation, the aerial drone 300 may be configured to provide optimized detection and avoidance (DAA), particularly by utilizing the resources and/or capabilities incorporated therein, such as sensing and computing/processing resources and capabilities, to facilitate and/or support performing detection and avoidance (DAA) related functions, and doing so in enhanced manner. Use of such optimized detection and avoidance (DAA) may be particularly advantageous for certain types of operations, such as beyond visual line of sight (BVLOS) operations. For example, in instances where drones such as the aerial drone 300 are configured to support beyond visual line of sight (BVLOS) operations, the drones may incorporate radars configured to provide wide field of view (e.g., preferably full (360°) field of view) coverage, and may further support automatic dependent surveillance-broadcast (ADS-B), camera feed, and possibly thermal imaging. Use of capable radar(s), especially radar(s) with low size, weight, power and cost (SWaP-C), which may provide at least 90° but preferably full (360°) field of view coverage is very desirable, particularly in the azimuth direction. In this regard, where full (360°) field of view coverage may not be possible, a radar with 90° field of view may be used to acquire full (360°) field of view coverage—e.g., with the drone being spun around in a stepped scan approach (90° at a time), or with multiple radars may be used (e.g., 4 radars each providing at least 90° coverage, or 3 radars each providing at least 120° coverage), with these multiple radar arranged to provided full (360°) field of view coverage (the 4 radars facing in 4 different directions when using radars each providing at least 90° coverage, or the 3 radars facing in 3 different directions when using radars each providing at least 120° coverage).

In some implementations, one or more radar(s) may also be placed on top, bottom, or both top and bottom of the drone, for complete 360° spherical coverage. In this regard, placement of radar(s) on top may be advantageous as it may enable for and/or support detecting aircraft and other objects above the drone. The use of ADS-B provides plane data may be also allow for providing flight plan.

In some instances, drones such as the aerial drone 300 may incorporate an autonomous detection and avoidance (DAA) engine. In this regard, the aerial drone 300 may be configured to (e.g., via processors used therein) implemented and apply optimized algorithms for processing and using sensor data (e.g., in determining desirable or optimal course of action).

In some instances, detection and avoidance (DAA) may be used in conjunction with enhanced data communications in drone based mesh networks. For example, as noted the aerial drone 300 may incorporate advanced radios such as the radar/communication module(s) 310, such as DopplerSpace radios. With respect to communication performance, the radar/communication module(s) 310 may support high-speed long-range data (e.g., >200 Mbps up to 1 km), may have large field of view (e.g., 120° in azimuth and elevation). The radar/communication module(s) 310 may support use of secure data link(s) (e.g., with AES-256 encryption).

In some instances, the radar/communication module(s) 310 may be configured to provide and/or support use of local high bandwidth mesh to enable the drone to connect to other drones and/or network devices. Such local mesh may allow for connecting to drones, fixed sites (e.g., sensor(s) with radios), police cruiser, sensors, etc. For example, mesh connectivity may be provided using DopplerSpace 24 GHz phased array, which may allow for communication at, for example, 400 Mbps at 600 m, 200 Mbps at 1 km, and/or 2 Mbps at 20 km. Local device connectivity may be provided using 802.11n dual band, which may allow up to 10 WiFi users (e.g., at 433 Mbps), and/or via wired Ethernet for expanded users. Such mesh connectivity may be suitable for various use applications, such as distributed sensor networks, sensor fusion applications, etc.

In some instances, drones such as the aerial drone 300 may be configured to form and/or operate within a sensor mesh. In such instances, some of the drones may comprise high performance embedded CPU and GPU processor(s) for use in data processing, particularly in conjunction with handling processing and fusing gather sensory data.

As noted, in some instances, drones such as the aerial drone 300 may be configured to support various advanced computing based tasks, such as real-time artificial intelligence (AI) and data analytics, which may be used in conjunction with detection and avoidance (DAA) related functions. In this regard, the aerial drone 300 may be configured to provide software defined artificial intelligence (AI) sensing and autonomous responses. This may be particularly possible and/or optimized in conjunction with the detection and avoidance (DAA) related functions. In this regard, such AI based solution may include and/or entails use of AI sensing, AI autonomy, and AI cloud services. With respect to AI sensing, data acquisition may be performed using DopplerSpace (radar/radios). In this regard, formed RF meshes may enable new levels of data sharing for distributed sensing. Such radars may be optimized for drones or handheld devices. AI software may fuses optical and radar (data), such as using AI deep learning. The software may integrate data from 3rd party optical, LIDAR, thermal/IR and other sources as needed. Sensors may be handheld, ground based, and/or deployed on drones. Multiple object classification & tracking, even in foggy or smoky conditions.

Artificial intelligence (AI) Autonomy may be utilized when acting on acquired data. Sensors, people, vehicles and drones may coordinate data in real-time through RF mesh network. Autonomy software may be used to enable and ensure autonomous drone response and provide AI based assistance to operators. This may allow for multiple object classification and tracking, even in low visibility (e.g., foggy or smoky) conditions. Automated drones may extend sensing over distance and rapidly inspect areas of interest. This may allow for intelligent detect and avoid, or detect and track navigation.

In some instances, sensor data may be rendered into detailed three-dimensional (3D) models (e.g., terrain, structures, areas of interest, etc.). The use of such service may also allow for detecting safety hazards (e.g., in structures, terrain, certain locations, etc.), and/or detecting safety/security issues. In some instances, open architecture may be used/supported to enable running or incorporate applications from different sources (e.g., combining provider's proprietary neural networks with user's and/or 3rd party's AI applications).

In some instances, the aerial drone 300 may be configured for operation within network arrangements configured for other advanced and/or specialized services, such as, e.g., enabling enterprises-scale deployment of aerial vehicles, ground vehicles, fixed sensors, and more, interoperating with any existing networks using intelligent routing at the edge, and/or securing data from end-to-end using fully encrypted links (AES-256).

In some implementations, detection and avoidance (DAA) may be utilized in mesh based settings (e.g., where the drone incorporating detection and avoidance (DAA) operates in proximity to and/or in conjunction other nodes in a mesh, which may comprise, e.g., other drones and/or non-drone nodes, such as radar sensors. In this regard, some of the nodes in the mesh may be fixed and/or ground based. For example, in various use case scenarios associated with mesh-based operation, the drone incorporating DAA functions may be configured to use DAA to detect based on shared info (e.g., ADS-B), to use DAA to detect for unknown objects (e.g., other drones), such as using radar, optical or other sensory information, to use DAA for navigation (e.g., avoid objects), etc.

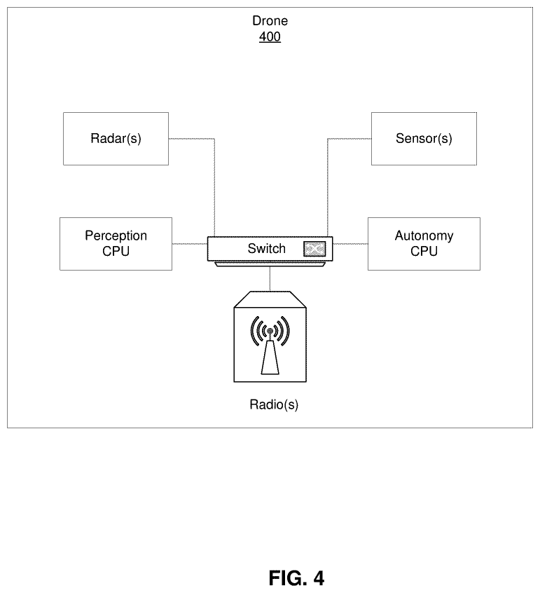

FIG. 4 shows an example implementation of drone that may be configured for detection and avoidance in accordance with an example embodiment of the disclosure. Shown in FIG. 4 is aerial drone 400 that is configured for supporting detection and avoidance as described herein. The aerial drone 400 may correspond to an implementation of the aerial drone 300 as described with respect to FIG. 3.

The aerial drone 400 may comprise suitable circuitry and other components (e.g., hardware or otherwise) to facilitate operation in accordance with the present disclosure. For example, as shown in FIG. 4, the aerial drone 400 comprises a perception processor/circuit (or CPU), a autonomy processor/circuit (or CPU), radio(s), radar(s) and other sensor(s) for obtaining sensory related data, and a switch for facilitating interactions among the various elements of the aerial drone 400. The perception processor/circuit (or CPU) and the fusion processor/circuit may be configured to facilitate and support, inter alia, AI based sensing, data fusing, and data sharing functions, as described herein. The radio(s) may be configured for supporting communications by the aerial drone 400, such as, e.g., with other drones and/or other network elements within a mesh network comprising the aerial drone 400. The disclosure is not limited to particular type of radios, and any type of radio may be used so long as suitable for operation in drone-based environment. In an example implementation, commercially available radios are used. In an alternative implementation, mesh radios, which may be optimized for supporting forming and operating mesh networks of drones, are used.

The radars may be configured to provide or facilitate providing full (360°) field of view coverage. In this regard, as noted above the radars used in the drones may be configured to provide wide field of view (e.g., preferably full (360°) field of view) coverage. The radars may be optimized with respect to size, weight, power and cost (SWaP-C). In some instances, a single radar providing full (360°) field of view coverage. Alternatively, radars providing less than full field of view may be used, with the full field of view coverage achieved by, e.g., using multiple radars positioned to collectively and simultaneously provide full field of view coverage, or with the drone and/or the radars being spun around in a stepped scan approach (e.g., 90° at a time).

The sensors may configured to obtain sensory data that may augment radar based data. The sensors may be one or more sensors configured to support multiple data-type capture, e.g., automatic dependent surveillance-broadcast (ADS-B) based sensory, camera feed, thermal imaging, etc.

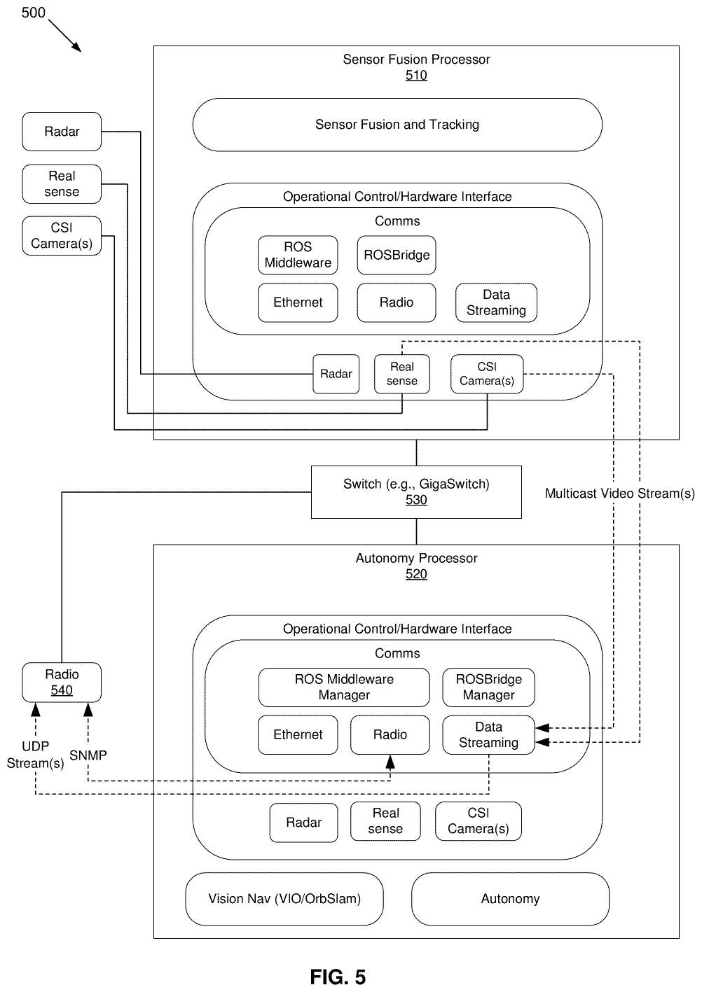

FIG. 5 shows an example architecture of an artificial intelligence (AI) drone that may be utilized in accordance with an example embodiment of the disclosure. Shown in FIG. 5 is artificial intelligence (AI) drone 500 (or a portion thereof) that may be configured for supporting detection and avoidance as described herein. The drone 500 may correspond to an example implementation of the AI Drone 400 of FIG. 4. The drone 500 comprises a sensor fusion processor, an autonomy processor, a switch 530 (e.g., a mini 1G switch (GigaSwitch)), and a radio 540 (e.g., P2P/mesh radio).

Illustrated in the example implementation shown in FIG. 5 are various example subcomponents of some of the components of the drone 500 (e.g., the sensor fusion processor or circuit 520 and the autonomy processor or circuit 530) and example interactions between the components of the drone 500, in accordance with an example implementation, specifically to facilitate and support the AI based sensing, fusing, processing, controlling, etc. in the drone 500, such as in the course of or in support of detection and avoidance related operations.

In some examples, the drone 500 is equipped with a listing of threats, arranged in a look-up-table (LUT), recognition library, and/or connected to a network with access to a source of threats. The listing may categorize threats according to characteristics provided by sensors incorporated with the drone 500 (and/or within the mesh network). For example, a drone equipped with an optical camera may store images of known threats (e.g., buildings, aerial vehicles, birds, etc.), and be able to identify such threats through image recognition technologies. Once identified, a number of correlated avoidance measures may be recommended to an operator and/or implemented automatically. In an example, if a building is identified within the flight path, the autonomy processor 520 may instruct the drone 500 to stop, increase in altitude and/or move to a side as the drone proceeds. Information regarding identified threats may also be transmitted to other nodes in the mesh network, which may include a position or movement of the threat in addition to the type of threat.

Further, identification and/or determination of an avoidance measure may be based on data from multiple radar and/or sensors, and implemented via an AI or ML program (e.g., for unknown threats), and may receive updates from other nodes in the mesh network and/or from a connected data source. In an example, if a conflict between sensor data exists, data from a first sensor type may be prioritized over a second sensor type. Prioritization may depend on environmental circumstances (e.g., fog or smoky conditions may favor radar) and/or character of the threat (e.g., size, composition, relative movement, etc., may be better identified via optical imaging, thermal imaging, laser scanning, etc.).

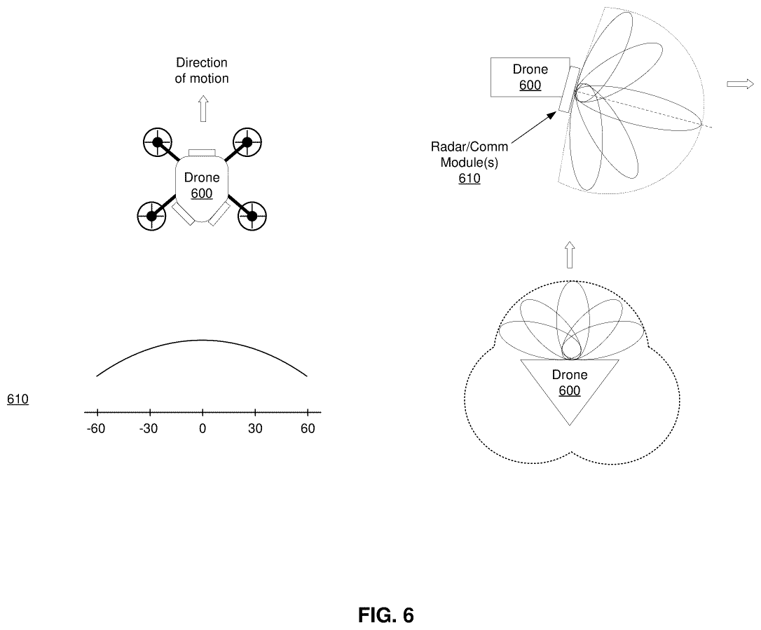

FIG. 6 shows an example drone incorporating three radar/communication module(s) arranged for providing full field of view. Shown in FIG. 6 is an aerial drone 600.

The aerial drone 600 may comprise suitable circuitry and other components (e.g., hardware or otherwise) to facilitate and support detection and avoidance (DAA), in accordance with the present disclosure. The aerial drone 600 may be substantially similar to, and/or may be configured to operate in substantially similar manner as other aerial drones described herein (e.g., the aerial drone 300 of FIG. 3, the aerial drone 400 of FIG. 4, etc.), particularly with respect to detection and avoidance (DAA) related functions and/or operations. The aerial drone 600 represents an example implementation in which three radar/communication module(s) (e.g., each of which similar to the radar/communication module(s) 310 described herein) are utilized, with these three modules arranged to provide wide field of view (e.g., preferably full (360°) field of view) coverage.

In this regard, as noted it is desirable to have or provide DAA with full (360°) field of view coverage (also referred to herein as “360° DAA.”) In particular, having such full (360°) field of view coverage is advantageous to not only allow for detecting and locating static or moving objects (or obstacles) along the drone's flight path, but also to enable detecting moving objects that may be to the sides and/or rear of the drones, which may be approaching the drone (e.g., moving faster than the drone, such as an airplane or a helicopter), and as such may cross paths with the drone even though are not along the drone's flight path—that is, not in drone's direction of movement. The drone may need to conduct DAA maneuvers in these scenarios as well, such as when determining that a detected object may pose a threat to the drone—e.g., is a collision course with the drone. As noted, radars may be used to provide the required detection functions. In this regard, radar are commonly used on aircrafts or the like to provide such detection. However, conventional radars are too heavy (particularly for light weight drones), and using multiple radars (e.g., three or more radars) to provide full (360°) field of view coverage may not be feasible or desirable as the combined weight of such heavy radars may limit the functionality of the drone—e.g., consume all available payload and more. Solutions based on the present disclosure may address these issues by use radars having much lighter weight, which allow use of multiple radars for detection without taking up all or even most of the payload.

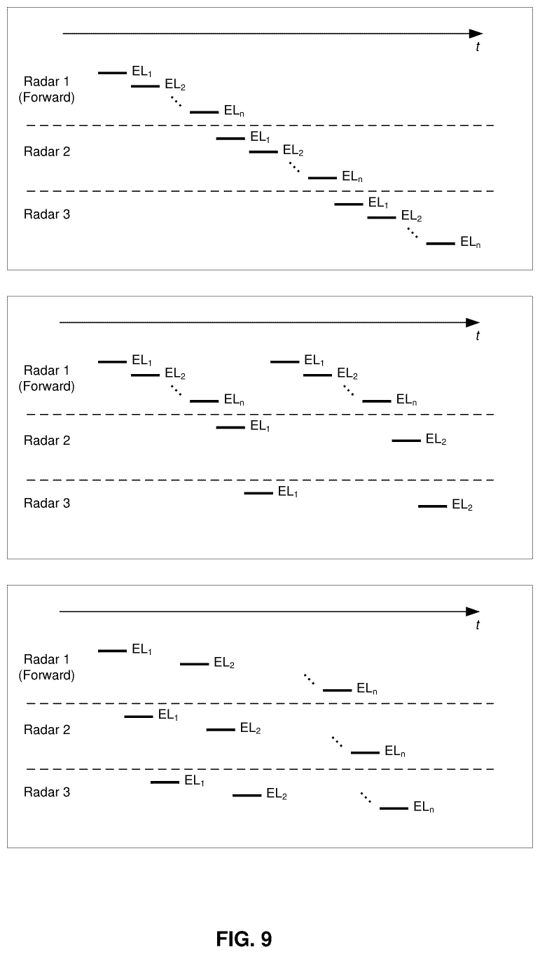

Another consideration is power consumption, as radars (or similar detectors) require considerable power, especially conventional radars. Radars used in solutions in accordance with the present disclosure may be configured to utilize considerably less power. This may be achieved by optimizing the radars to reduce power consumption in each of them, and/or in by utilizing schemes to optimize overall power consumption, such as by operating the radars in such a way where not all radars are used simultaneously. For example, timing schemes may be used where only some of the radars are used, such as one radar at a time, with the radars operating one after the other in a pre-determined sequence. Doing so will clearly result in reduced power consumption. For example, a typical drone may use 250-500 W during flight, and cycling through multiple radars as described will result in lower power consumption—e.g., where each radar requires 25 W, cycling through multiple radars will only consume 25 W whereas if all radars are used simultaneously the power consumption will increase, such as to 75 W in a drone having 3 radars, when all radars are used all the time. Examples of such timing schemes are illustrated and described in more detail with respect to FIG. 9.

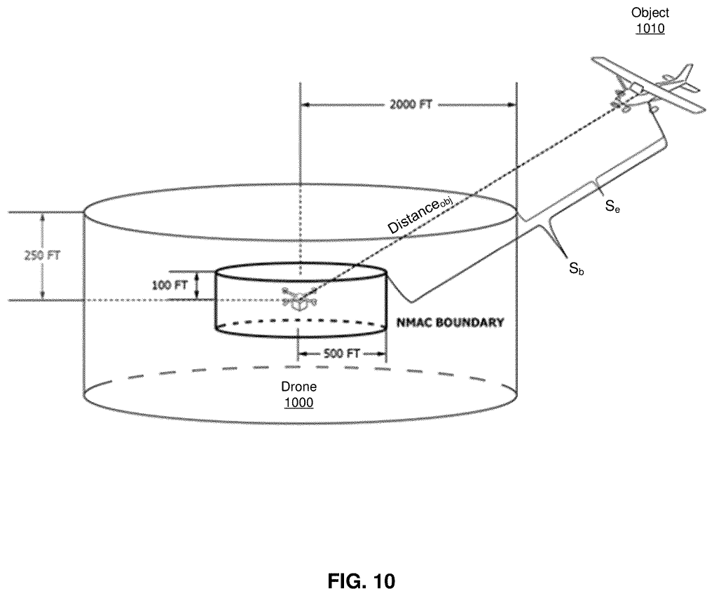

Use of 360° DAA may offer various benefits, including, e.g., improving regulatory, such as the Federal Aviation Administration (FAA), approval rate for beyond visual line of sight (BVLOS) operation, and compliance with applicable standards, including American Society for Testing and Materials (ASTM) standards, such as ASTM F3442/F3442M-20, which defines requirements and risk ratios for maintain safe operations. For example, use of such DAA solutions may ensure meeting near mid-air collision (NMAC) clearance requirements—e.g., 500 ft. horizontal and 100 ft. vertical clearance requirements. This is illustrated in FIG. 10.

As described herein, in various implementations multiple radar/communication modules may be used to provide 360° DAA. Such radar/communication modules may incorporate phased array antennas (and as such are also referred to as “phased array antenna modules” or simply “antenna modules.”) In this regard, various configurations of phased array antenna modules arranged around a suitable platform, such as a drone, may be used. Each of the antenna modules may be a module that comprises an antenna and suitable circuitry (and any additional required hardware resources), which may be configured to conduct communications and/or radar functions. The antenna(s) may be phased array antennas or various configurations of antennas, but may generally have a general property of, and/or may generally operate as a directional antenna such that multiple antenna modules may be used to expand the communications or detection regions. For example, the antenna module may be a phased array based module, a metamaterials-based antenna based module, or various active and passive configurations, which may result in an antenna with a particular beamwidth characteristics—e.g., generally less than 90° in azimuth and elevation. The antenna may be fixed or steerable antennas.

Use of multiple antenna modules may be offer various advantages and/or improvement. In this regard, some drones may use a single radar configuration to detect objects along the drone's forward path. While helpful in detecting objects and/or avoiding obstacles related to the drone's trajectory, such configuration may not be does not help in avoiding moving objects from other directions that have higher velocities. In such instances, a larger detection coverage region, particularly a full (360°), or near-full field of view coverage, would offer enhanced detection (and thus, where used, avoidance). In some instances, multiple antenna modules configuration may be used to provide a full spherical coverage region would, such as by utilizing antenna modules to provide detection to the top and bottom, in addition to the antenna module(s) used in providing full field of view in the azimuth. Nonetheless, such full spherical coverage region may not be always necessary or needed. For example, if the drone only operates at low altitudes, removal of the bottom-facing antenna module(s) may be possible. Additionally, where the antenna modules may be capable of observing over a wide elevation angle, either with wide beamwidth or through scanning, it may be possible to clear detection requirements without requiring use of top-facing antenna module(s). As such, in most instances only a 360° azimuth configuration would be required.

The 360° configuration may be satisfied in a variety of ways. For example, as described above, in some implementations, place four (4) antenna modules may be used, each with 90° coverage. Alternatively, where the antenna modules may be configured to provide 120° coverage, three (3) antenna modules may be sufficient to provide full (360°) coverage. On possible embodiment, illustrated in FIG. 6 with respect to the drone 600, is to have one antenna module facing forward for optimized coverage in the direction of travel, with the remaining two antenna modules placed on the sides (and facing a bit to the rear), to provide detection coverage in the other directions, forming the other sides of the triangle.

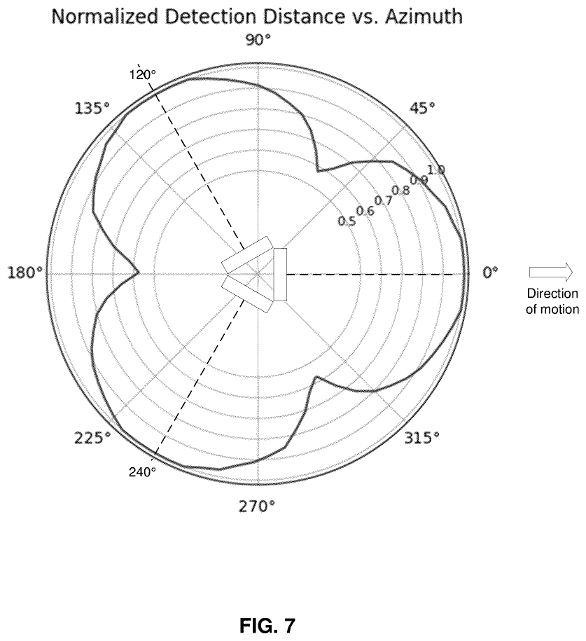

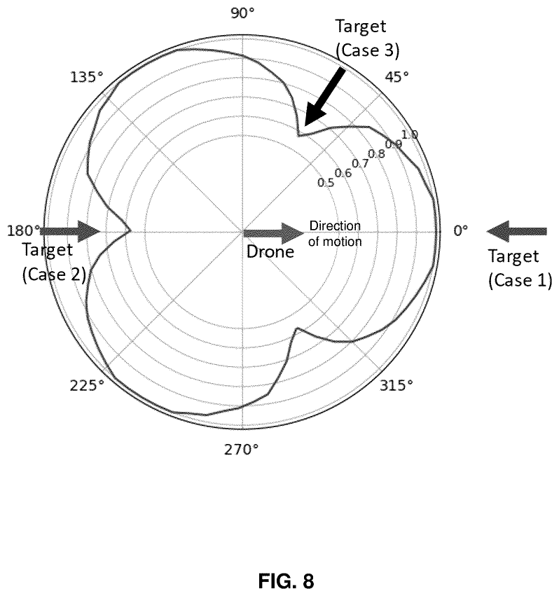

In some instances, the antenna modules may not have exactly 120° of coverage, but slightly degraded coverage ranges at the vertices of the antenna module assembly would be acceptable. In other words, the coverage region may not be uniform, with detection distances varying around the platform. This is illustrated and described in more detail with respect to FIGS. 7-8 below. This is especially true on a platform such as a drone that will be moving and rotating such that the degraded regions will not always be in the local direction. The variation in detection distance may be particularly relevant with respect to the antenna module facing forward, providing detection in the direction of travel, as illustrated in chart 610. Further, the antenna coverage for each antenna module may not be the same in all directions, such as, e.g., relative to the face of antenna array (where one is used), with better detection in perpendicular directions relative to other directions, as illustrated in FIG. 6.

FIG. 7 shows detection coverage area of an example drone incorporating three radar/communication module(s). Shown in FIG. 7 is a graph 700.

The graph 700 comprises a plot representing normalized detection distance for a full (360°) field of view relative to the azimuth for a drone. In this regard, the azimuth (0°) corresponds to the direction of movement for the drone. As shown in FIG. 7, the graph 700 corresponds to a drone with 3-module arrangement, such as the drone 600 of FIG. 6, having one radar/communication module on the front and two radar/communication modules facing sideway (and to the back), at 120° degree on each side relative to the front-facing radar/communication module. As illustrated in graph 700, the normalized detection distance may not be uniform for the full (360°) field of view. Rather, due to the antenna patterns of the radars, normalized detection distance may be maximal (longest) at locations corresponding to the positions of the three radar/communication modules—that is, in the direction each of the radar/communication module faces—and may be minimal at locations between the radar/communication modules.

Further, normalized detection may not necessarily be optimized at the locations where the normalized detection distance may be maximal, as other factors (e.g., movement of the drone (direction and speed), movement of (direction and speed) of detected objects, relative positions of drone and detected objects, etc.) may also affect the timeliness of detection—that is, how much time the drone has to detect (and thus possibly react to) objects or other obstacles in its environment. This is illustrated in and described in more detail with respect to FIG. 8.

FIG. 8 shows variations in required detection time for different targets relative to a coverage area of an example drone incorporating three radar/communication module(s). Shown in FIG. 8 is (again) the graph 700 as described with respect to FIG. 7.

In this regard, as noted with respect to FIG. 7, the normalized detection distance may not be uniform for the full (360°) field of view of the drones, with the normalized detection distance instead being maximal (longest) at some locations (e.g., corresponding to the positions of the radar/communication modules on the drones), and minimal at locations between the radar/communication modules. The variations in normalized detection distance, in combination with other factors, may cause variations in amount of response time the drone has to react to detected objects and/or other physical obstacles. In particular, the other factors may comprise direction and/or speed of the drones, direction and/or speed of objects (if moving), relative positions of the objects and the drones, etc.

For example, three different cases are illustrated in FIG. 8. In this regard, case 1 correspond to direct head-on collision scenario, where an object (e.g., another drone, an airplane, etc.) is moving directly into the drone—that is, both the drone and the object are moving along the same path but in opposite directions. In case 2, an object (e.g., another drone, an airplane, etc.) is directly following the drone—that is, both the drone and the object are moving along the same path and in the same direction, but with some separation therebetween. As such, the object in case 2 may be approaching the drone from a direction that present a worst case detection range angle—that is, where normalized detection distance is minimal. In case 3, an object (e.g., another drone, an airplane, etc.) may be approaching the drone from a direction that present a worst case detection range angle—that is, where normalized detection distance is minimal, but which is not along the same path as the drone.

As such, while case 1 may correspond to one of the case detection range angle, because it correspond to direct head-on collision it may be the worst case as it represents maximum closing speed-since the drone and objects are moving towards one another along the same path. Further, while both case 2 and case 3 may correspond to one of the (three) worst case detection range angles, case 2 may be less concerning as it corresponds to the minimum relative closing speed scenario. In other words, the relative closing speed in case 3 is higher than the relative closing speed in case 2.

FIG. 9 shows an example timing scheme that may be used in an example drone incorporating three radar/communication module(s). Shown in FIG. 9 are timing graphs 900, 910, and 920.

The timing graphs 900, 910, and 920 illustrating example timing sequences that may be used when utilizing multiple radars. In this regard, in some implementations, when utilizing multiple radar/antenna modules, the multiple radar/antenna modules may be configured to apply and/or follow a timing scheme with respect to transmissions thereby when searching for objects or other obstacles—that is, when performing detection related functions. For example, when using multiple radar/communication modules (e.g., 3 radar/communication modules in the drone 600), the radars (e.g., all 3 in the drone 600, or any combination thereof) may either operate independently or in a coordinated manner. One approach that may be used for coordinated operations is for the radars to operate in a time division or interleaved manner. For example, one radar may conduct its operation—e.g., gathering radar returns and/or conducting a scan, then it would suspend radar operations while the next radar conducts its operations, and so forth.

The timing of such operations may be optimized for modes of operation. One example is equal operation for all antenna modules. Another example is for the forward-facing antenna module to have priority since it is in the direction of travel, with reduced time allocated to the other antenna modules. One example scenario is for the forward-facing antenna module to scan its full field of view, then the other antenna modules scan only one portion of their field of view at a time. The other antenna modules may use subsequent time allocations to complete their scan. Alternatively, the other antenna modules may prioritize their allocated scan time to focus in certain directions such as looking up if the drone is flying low to the ground. The antenna modules may also switch to tracking modes, where scanning would be suspended to allow a particular target to be tracked with a longer dwell time.

A few of these possible scenarios are illustrated in the graphs 900, 910, and 920. In this regard, in each of the graphs the x-axis is time (t). Each short line in the graphs represents a scan in the azimuth direction (constant elevation). The graph 900 illustrates a first approach, in which the radar 1, which the forward-facing radar in the drone 600, completes azimuth scans at incremental elevation scans (EL₁, EL₂, . . . , ELₙ) until the desired scan volume is complete. This process is then completed similarly by radar 2 and then radar 3.

The graph 910 illustrates a second approach, in which priority is shown for radar 1 (the forward-facing radar), where it completes a full volume scan (EL₁, EL₂, . . . , ELₙ) for every elevation slice by the remaining radars. As such, when utilizing timing scheme illustrated in the graph 910, the drone is basically configured to maintain primary focus in the direction of movement (using radar 1), while using the other radars to for periodic checks in the other directions for situational awareness.

The graph 920 illustrates a third approach, in which a more rapidly revolving scan is used where a constant elevation scan is completed by each of the three radars sequentially, then repeats for the next constant elevation scan.

In some instances, when performing DAA related operations using multiple radars, the multiple radars may be configured to interleave at one frame per radar. For example, the system may be configured to combine multiple chirps—where chirps (or bursts) are the basic measurement of radar—into a single frame to get one complete measurement. A switch to/between the other radars may be done based on operation parameters of the system. In an example use scenario, each radar may be configured to use a frame time of 34 millisecond (ms) with a frame period of 37 ms, and as such each radar may actively transmit and receive chirps for 34 ms, then wait for the remaining time in the frame period—that is, 3 ms—before starting the next frame. The wait time of 3 ms may be used to, e.g., complete processing of the frame, to program the phased array to steer the beam, and other housekeeping elements. When interleaving radars that are precisely time aligned, a second radar may start a frame just after the first radar finishes its frame. The first radar could then use this time without chirp transmission to complete radar frame processing, beam steering, housekeeping, and even additional processing include artificial intelligence processing such as target classification. Use of interleaving in this manner may be done for, e.g., thermal and processing benefits. For example, with respect to thermal benefits, short/quick bursts may keep heat lower than keeping it on for longer time periods. This may be due to cool down characteristics of device/materials.

The disclosure is not limited to use of timing based coordination techniques, however, and in some implementations other types of coordination may be used. For example, in some implementations, frequency based coordination may be used when using multiple radar/communication modules. Based on a first example frequency-based approach, in some implementations, when using multiple radars (e.g., 3 radars as is the case in the drone 600), the radars may be configured to operate on different frequencies, and therefore may operate simultaneously. Based on a second example frequency-based approach, in some implementations, when using multiple radars, the radars may be configured to use and operate on a same frequency, and the system may be configured to sweep around the different radars. In this regard, sharing the same frequency may entail using suitable measures, in addition to timing scheme, to facilitate the use of the same frequency by the multiple radars. Such approach may offer the added benefit of consuming less power overall.

In some instances, when using multiple radars (e.g., 3 radars as is the case in the drone 600), various measures are used to synchronizing the multiple radars and operations thereof. In this regard, when using multiple radars in the system, the radar may need to have a common time reference or time base to properly align, segment, and synchronize the radar operations. The synchronization of the radars can be accomplished by using common timing signals such as frequency references and/or synchronization clocks such as a one pulse per second (1 PPS) clock. This may be particularly needed when utilizing coordinated operation techniques, such timing interleaving, frequency sweeping, etc.

FIG. 10 shows an example use scenario utilizing an example drone incorporating radar/communication module(s) for use in DAA. Shown in FIG. 10 is a drone 1000.

The aerial drone 1000 may comprise suitable circuitry and other components (e.g., hardware or otherwise) to facilitate and support detection and avoidance (DAA), in accordance with the present disclosure. The aerial drone 1000 may be substantially similar to, and/or may be configured to operate in substantially similar manner as other aerial drones described herein (e.g., the aerial drone 300 of FIG. 3, the aerial drone 400 of FIG. 4, and the aerial drone 600 of FIG. 6), particularly with respect to detection and avoidance (DAA) related functions and/or operations.

Illustrated in FIG. 10 is a use case scenario demonstrating use detection and avoidance (DAA) as described herein to provide and maintain particular clearance requirements. For example, the drone 1000 may be configured to ensure meeting particular near mid-air collision (NMAC) clearance requirements—e.g., 500 ft. horizontal and 100 ft. vertical clearance requirements. These clearance requirements may be used to define a boundaries envelop (shown as cylinder like space) around the drone. The drone 1000 may be utilize its radars as described herein to detect any objects in its environment, and may then assess any detected object, such as to determine if the object may pose a risk to violating its clearance requirements.

To that end, the drone 1000 may be configured to utilize encroachment distances, extending beyond the minimum clearance distances—e.g., 2000 ft. horizontal and 250 ft. vertical encroachment margins—in assessing the detected object. The encroachment margins may be used to define an encroachment envelop (shown as cylinder like space) around the drone around the drone, for use in assessing detecting objects. For example, the drone 1000 may utilize radar scans to determine the distance to the detected object (distance_{obj}), and then may determine, based on the calculated distance_{obj} and (optionally) other information (e.g., relative angles, orientation, and the like), separation (or distance) between the detected object and each the boundaries envelop and the encroachment envelop, Sb and Se. These measurements may then be used to determine when the detected object may pose a threat and/or how to respond—that is, in conjunction with the avoidance related functions.

An example system, in accordance with the present disclosure, comprises a plurality of radars, wherein each radar of the plurality of radars is configured to provide radar measurement capabilities, each radar of the plurality of radars is configured to provide at least a partial field of view coverage, and the plurality of radars is configured or arranged to provide an extended coverage detection area; and a host machine comprising one or more circuits, wherein the host machine is connected to each radar of the plurality of radars via a corresponding data connection; and wherein the one or more circuits are configured to manage or control operation of the plurality of radars; process radar measurements obtained via the plurality of radars; and provide or support detection related functions based at least in part on the processing of the radar measurements.

In an example embodiment, the plurality of radars is configured to collectively provide expanded coverage in at least one plane.

In an example embodiment, the plurality of radars is configured to collectively provide a full (360°) field of view coverage in the azimuth.

In an example embodiment, at least one radar is configured to provide less than a full field of view, with the at least one radar configured to scan an area of interest to ensure or enable providing the full (360°) field of view coverage in the azimuth.

In an example embodiment, the plurality of radars comprises four radars with each radar configured to provide at least 90° field of view in the azimuth, and with the four radars positioned in different directions to ensure or enable providing the full (360°) field of view coverage in the azimuth.

In an example embodiment, the plurality of radars comprises three radars with each radar configured to provide at least 120° field of view in the azimuth, and with the three radars positioned in different directions to ensure or enable providing the full (360°) field of view coverage in the azimuth.

In an example embodiment, at least one radar is configured to scan in a direction other than the one plane.

In an example embodiment, each radar of the plurality of radars is positioned and/or is configured to scan in a different direction to increase the field of view coverage.

In an example embodiment, managing or controlling operation of the plurality of radars comprises prioritization of radars based on prioritization criteria that comprise one or more of location on system and view coverage relative to a direction of travel of the system.

In an example embodiment, the plurality of radars is configured to operate simultaneously.

In an example embodiment, the plurality of radars is configured to operate on different frequencies, to enable simultaneous operation of the plurality of radars.

In an example embodiment, the plurality of radars is configured to operate on a same frequencies, and wherein the plurality of radars is further configured to operate based a timing multiplexing scheme.

In an example embodiment, when the plurality of radars is configured to operate based a timing multiplexing scheme, at least two radars are configured to operate at different times while using a same frequency for radar scanning. The at least two radars may be configured to operate at different times based on time synchronization signals.

In an example embodiment, at least one radar comprises or uses one or more electronically steerable antennas.

In an example embodiment, at least one radar is a frequency-modulated continuous-wave (FMCW) radar.

In an example embodiment, each radar weighs less than 1.5 lbs.

In an example embodiment, each radar is configured to consume less 30 watts during active operation.

In an example embodiment, each radar of the plurality of radars is configured to, when providing the radar measurement, emit a radio signal, receive a return signal from a target, and determine parameters related to the target. The parameters may comprise, e.g., range, velocity, and location.

In an example embodiment, the one or more circuits are configured to process at least some of the data using artificial intelligence (AI) based processing.

In an example embodiment, at least a portion of the system is embedded in or otherwise associated with an unmanned aerial vehicle (UAV), and wherein the UAV is configured to utilize information based on the detection related functions during operation of the UAV.

In an example embodiment, the one or more circuits are configured to provide avoidance related functions based at least in part on the data from the plurality of radars.

In an example embodiment, the one or more circuits are configured to implement an autonomous detection and avoidance (DAA) engine for use in providing one or both of the detection related functions and the avoidance related functions.

In an example embodiment, the autonomous detection and avoidance (DAA) engine is configured for processing sensor data and determining course of action based on the processing of sensor data.

An example node, in accordance with the present disclosure, is configured for operating within a communication network, with the node comprising a radio configured for communication within the communication network; one or more radars configured to provide at least 90° field of view coverage; and one or more circuits configured for one or both of controlling operations of the node and processing of data within the node; wherein the one or more circuits are configured to provide detection related functions based at least in part on data from the one or more radars while operating in the communication network.

In an example embodiment, the one or more radars are configured to collectively provide expanded coverage in at least one plane.

In an example embodiment, the one or more radars are configured to collectively provide a full (360°) field of view coverage in the azimuth.

In an example embodiment, the node further comprises a single radar configured to provide the full (360°) field of view coverage in the azimuth.

In an example embodiment, the node further comprises at least one radar configured to provide less than a full field of view, with the at least one radar being configured to scan an area of interest to ensure or enable providing the full (360°) field of view coverage in the azimuth.

In an example embodiment, the node further comprises four radars with each radar configured to provide at least 90° field of view, with the four radar positioned in different directions to ensure or enable providing the full (360°) field of view coverage in the azimuth.

In an example embodiment, the node further comprises three radars with each radar configured to provide at least 120° field of view, with the three radar positioned in different directions to ensure or enable providing the full (360°) field of view coverage in the azimuth.

In an example embodiment, the node further comprises a plurality of radars, with each radar of the plurality positioned in a different direction to increase the field of view coverage.

In an example embodiment, the one or more circuits are configured to manage or control operation of the plurality of radars.

In an example embodiment, the plurality of radars are configured to operate simultaneously.

In an example embodiment, the plurality of radars are configured to operate on different frequencies, to enable simultaneous operation of the plurality of radars.

In an example embodiment, the plurality of radars are configured to operate on a same frequencies, and wherein the plurality of radars are further configured to operate based a timing multiplexing scheme.

In an example embodiment, when the plurality of radars is configured to operate based a timing multiplexing scheme, at least two radars are configured to operate at different times while using a same frequency for radar scanning. The at least two radars may be configured to operate at different times based on time synchronization signals.

In an example embodiment, at least one radar comprises or uses one or more electronically steerable antennas.

In an example embodiment, at least one radar is a frequency-modulated continuous-wave (FMCW) radar.

In an example embodiment, each radar weighs less than 1.5 lbs.

In an example embodiment, each radar is configured to consume less 30 watts during active operation.

In an example embodiment, each radar is configured to providing the radar measurement, when providing the radar measurement, emit a radio signal, receive a return signal from a target, and determine parameters related to the target. The parameters may comprise, e.g., range, velocity, and location.

In an example embodiment, each radar is configured to, when providing the radar measurement, emit a radio signal, receive a return signal from a target, and determine parameters related to the target. The parameters may comprise, e.g., range, velocity, and location.

In an example embodiment, further comprising one or more sensory devices configured for obtaining sensory data.

In an example embodiment, the one or more sensory devices comprises a camera configured to obtain visual data.

In an example embodiment, the one or more sensory devices comprises a thermal device configured to obtain thermal imaging data.

In an example embodiment, the one or more sensory devices comprises a dependent surveillance-broadcast (ADS-B) based sensor device configured to obtain ADS-B based sensory data.

In an example embodiment, the one or more sensory devices comprises a lidar based sensor device configured to obtain lidar based sensory data.

In an example embodiment, the one or more circuits are configured to process data obtained by the node and/or by other nodes or network devices within the communication network.

In an example embodiment, the one or more circuits are configured to process at least some of the data using artificial intelligence (AI) based processing.

In an example embodiment, the node comprises or is embedded in an unmanned aerial vehicle (UAV), and wherein the UAV is configured to utilize detection based information during operation of the UAV.

In an example embodiment, the communication network comprises a mesh network.

In an example embodiment, the one or more circuits are configured to provide avoidance related functions based at least in part on the data from the one or more radars.

In an example embodiment, the one or more circuits are configured to implement an autonomous detection and avoidance (DAA) engine for use in providing one or both of the detection related functions and the avoidance related functions.

In an example embodiment, the autonomous detection and avoidance (DAA) engine is configured for processing sensor data and determining course of action based on the processing of sensor data.

As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the term “exemplary” means serving as a non-limiting example, instance, or illustration. As utilized herein, the terms “for example” and “e.g.” set off lists of one or more non-limiting examples, instances, or illustrations.

As utilized herein the terms “circuits” and “circuitry” refer to physical electronic components (e.g., hardware), and any software and/or firmware (“code”) that may configure the hardware, be executed by the hardware, and or otherwise be associated with the hardware. As used herein, for example, a particular processor and memory (e.g., a volatile or non-volatile memory device, a general computer-readable medium, etc.) may comprise a first “circuit” when executing a first one or more lines of code and may comprise a second “circuit” when executing a second one or more lines of code. Additionally, a circuit may comprise analog and/or digital circuitry. Such circuitry may, for example, operate on analog and/or digital signals. It should be understood that a circuit may be in a single device or chip, on a single motherboard, in a single chassis, in a plurality of enclosures at a single geographical location, in a plurality of enclosures distributed over a plurality of geographical locations, etc. Similarly, the term “module” may, for example, refer to a physical electronic components (e.g., hardware) and any software and/or firmware (“code”) that may configure the hardware, be executed by the hardware, and or otherwise be associated with the hardware.

As utilized herein, circuitry or module is “operable” to perform a function whenever the circuitry or module comprises the necessary hardware and code (if any is necessary) to perform the function, regardless of whether performance of the function is disabled or not enabled (e.g., by a user-configurable setting, factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, various embodiments in accordance with the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While various spatial and directional terms, such as top, bottom, lower, mid, lateral, horizontal, vertical, front and the like may be used to describe embodiments, it is understood that such terms are merely used with respect to the orientations shown in the drawings. The orientations may be inverted, rotated, or otherwise changed, such that an upper portion is a lower portion, and vice versa, horizontal becomes vertical, and the like.

It is to be understood that the disclosed technology is not limited in its application to the details of construction and the arrangement of the components set forth in the description or illustrated in the drawings. The technology is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A system comprising:
a plurality of radars, wherein:
each radar of the plurality of radars is configured to provide radar measurement capabilities,
each radar of the plurality of radars is configured to provide at least a partial field of view coverage,
the plurality of radars is configured or arranged to provide an extended coverage detection area based on at least two radars of the plurality of radars being configured or arranged to provide detection in different directions and/or to have only partial overlap of coverage; and
a host machine comprising one or more circuits,
wherein the host machine is connected to each radar of the plurality of radars via a corresponding data connection; and
wherein the one or more circuits are configured to:
manage or control operation of the plurality of radars;
process radar measurements obtained via the plurality of radars; and
provide or support detection related functions based at least in part on the processing of the radar measurements.

2. The system of claim 1, wherein the plurality of radars is configured to collectively provide expanded coverage in at least one plane.

3. The system of claim 2, wherein the plurality of radars is configured to collectively provide a full (360°) field of view coverage in the azimuth.

4. The system of claim 3, wherein at least one radar is configured to provide less than a full field of view, with the at least one radar configured to scan an area of interest to ensure or enable providing the full (360°) field of view coverage in the azimuth.

5. The system of claim 2, wherein the plurality of radars comprises four radars with each radar configured to provide at least 90° field of view in the azimuth, and with the four radars positioned in different directions to ensure or enable providing the full (360°) field of view coverage in the azimuth.

6. The system of claim 2, wherein the plurality of radars comprises three radars with each radar configured to provide at least 120° field of view in the azimuth, and with the three radars positioned in different directions to ensure or enable providing the full (360°) field of view coverage in the azimuth.

7. The system of claim 2, wherein at least one radar is configured to scan in a direction other than the one plane.

8. The system of claim 1, wherein each radar of the plurality of radars is positioned and/or is configured to scan in a different direction to increase the field of view coverage.

9. The system of claim 1, wherein managing or controlling operation of the plurality of radars comprises prioritization of radars based on prioritization criteria that comprise one or more of location on system and view coverage relative to a direction of travel of the system.

10. The system of claim 1, wherein the plurality of radars is configured to operate simultaneously.

11. The system of claim 10, wherein the plurality of radars is configured to operate on different frequencies, to enable simultaneous operation of the plurality of radars.

12. The system of claim 1, wherein the plurality of radars is configured to operate on a same frequencies, and wherein the plurality of radars is further configured to operate based a timing multiplexing scheme.

13. The system of claim 12, wherein, when the plurality of radars is configured to operate based a timing multiplexing scheme, at least two radars are configured to operate at different times while using a same frequency for radar scanning.

14. The system of claim 13, wherein the at least two radars are configured to operate at different times based on time synchronization signals.

15. The system of claim 1, wherein at least one radar comprises or uses one or more electronically steerable antennas.

16. The system of claim 1, wherein at least one radar is a frequency-modulated continuous-wave (FMCW) radar.

17. The system of claim 1, wherein each radar weighs less than 1.5 lbs.

18. The system of claim 1, wherein each radar is configured to consume less 30 watts during active operation.

19. The system of claim 1, wherein each radar of the plurality of radars is configured to, when providing the radar measurement, emit a radio signal, receive a return signal from a target, and determine parameters related to the target.

20. The system of claim 1, wherein the one or more circuits are configured to process at least some of the data using artificial intelligence (AI) based processing.

21. The system of claim 1, wherein at least a portion of the system is embedded in or otherwise associated with an unmanned aerial vehicle (UAV), and wherein the UAV is configured to utilize information based on the detection related functions during operation of the UAV.

22. The system of claim 1, wherein the one or more circuits are configured to provide avoidance related functions based at least in part on the data from the plurality of radars.

23. The system of claim 22, wherein the one or more circuits are configured to implement an autonomous detection and avoidance (DAA) engine for use in providing one or both of the detection related functions and the avoidance related functions.

24. The system of claim 22, wherein the autonomous detection and avoidance (DAA) engine is configured for processing sensor data and determining course of action based on the processing of sensor data.
